(19) United States
(12) Patent Application Publication
(10) Pub. No.: US 2025/0242294 A1
(43) Pub. Date: Jul. 31, 2025

(54) ROTARY SORPTION SYSTEM INCLUDING RECYCLED ISOLATION LOOP AND PURGE STREAM

(71) Applicant: MUNTERS CORPORATION, Amesbury, MA (US)

(72) Inventors: John Thompson, Newmarket, NH (US); Douglas Jefferson, Salem, MA (US); Cheryl Thibault, Newburyport, MA (US)

(21) Appl. No.: 18/645,824

(22) Filed: Apr. 25, 2024

Related U.S. Application Data
(60) Provisional application No. 63/627,057, filed on Jan. 30, 2024.

(51) Int. Cl. B01D 53/06; B01D 53/26

(52) U.S. Cl. CPC B01D 53/06; B01D 53/261; B01D 2253/106; B01D 2257/402; B01D 2257/708; B01D 2257/80; B01D 2259/40081; B01D 2259/4009

(57) ABSTRACT

A rotary sorption system includes a rotor formed of a rotating sorbent mass of a regenerable sorbent material, with which in a cycle of operation, a given volume of the sorbent mass sequentially passes through first, second, third, fourth, and fifth zones, before returning to the first zone. The system also includes a supply fluid stream directed through the first zone, a regeneration fluid stream directed through the third zone, and an isolation fluid stream that recirculates in a closed loop independent of the process fluid stream and the regeneration fluid stream through the second and fourth zones. A portion of the supply fluid stream passes through the fifth zone before joining the regeneration fluid stream and passing through the third zone, and no seal or barrier is disposed at a face of the rotor between the first zone and the fifth zone.

### CROSS-REFERENCE TO RELATED APPLICATIONS

This application claims the benefit under 35 U.S.C. § 119(e) of U.S. Provisional Patent Application No. 63/627,057, filed Jan. 30, 2024, and entitled “ROTARY SORPTION SYSTEM INCLUDING RECYCLED ISOLATION LOOP AND PURGE STREAM,” the entirety of which is incorporated herein by reference.

### FIELD OF THE INVENTION

The present invention relates generally to heating, ventilating, and air conditioning (HVAC) systems and methods, and can be applied to air conditioning, dehumidification, or drying systems that incorporate a thermally activated desiccant wheel, that is, a rotary sorption system, among other systems. The present invention relates, in particular, to a rotary bed sorption system and method that includes both a recycled isolation loop and a purge stream. The invention also relates to methods of designing and operating such a system.

### BACKGROUND OF THE INVENTION

Rotary bed sorption systems have long been used to collect a sorbate from one fluid stream, sometimes called a process or sorption fluid stream, and transfer it, in a more concentrated form, to a second fluid stream, sometimes called a desorption, reactivation, or regeneration fluid stream. The terms “regeneration” and “reactivation” will be used interchangeably in this specification. Commonly removed sorbates include water vapor, volatile organic compounds (“VOCs”), nitrous oxides (“NOx”), and the like.

As to removing water vapor, dehumidification is defined as a process of removing water vapor or moisture from air, and several methods of dehumidifying air are known. Those commonly utilized involve refrigeration, desiccants, or both, as in a hybrid system. In the case of dehumidification using refrigeration, moisture from an airstream passed over a cooling coil condenses, thereby reducing the moisture in the air stream. In the case of dehumidification using desiccants, the process is one of absorption or adsorption. For absorption, either liquid or solid desiccants are used, typically halide salts or solutions. For adsorption, solid desiccants like silica gel, activated alumna, molecular sieve, etc., are used.

It is important in a rotary bed sorption system, particularly one in which a low sorbate concentration is desired in the treated fluid, to minimize any cross-contamination between the process fluid stream and the regeneration fluid stream. Contamination can result from pressure differences in the fluid streams themselves, or vapor pressure differences within the matrix of the rotating sorbent disk.

Another source of possible contamination lies in areas of the sorbent disk that are adjacent to the active sorptive area, but that do not see active fluid flow during the cycle. Usually these are the areas at the center and outer periphery of the sorbent disk that are covered by sealing systems that may include seals and/or partitions. Typically, sorbent disks are intentionally designed to have these “dead zones,” which act as a thermal insulator, keeping the rotor housing cool and preventing its thermal expansion, which could lead to premature mechanical failure of the component. It has been demonstrated that in systems designed to achieve a very low sorbate concentration in the treated fluid stream, these areas can act as “sinks” for the vapor being removed. The sinks accumulate vapor when they are adjacent to the regeneration zone, where they are exposed through diffusive forces to the high concentration of the vapors in the regeneration zone, but are not subject to the heat of the regeneration, due to the high insulating characteristics of the glass/ceramic structure. The sorbent then can come to near equilibrium with the high-concentration vapor, but at a much lower temperature. The sinks release their payload when they are adjacent to the very low-concentration fluid in the process section of the system. The vapor pressure difference overcomes the diffusive force of the structure, and trace amounts of vapor are released into the treated fluid stream, causing detrimental increases in the concentration of the vapor being removed.

It is known to incorporate purge zones in rotary bed sorption systems. An example of a sorption bed system including a recirculating purge loop is disclosed in U.S. Pat. No. 4,701,189. It is also known to use one or more isolation fluid streams or loops in order to reduce cross-contamination between sorption and desorption zones of rotary sorption beds. U.S. Pat. No. 7,101,414 describes several embodiments in which one or more isolation loops are used to achieve different goals. U.S. Pat. No. 11,413,570 describes combining purge and isolation streams. However, the use of partitions and seals at the face of the rotary sorption bed can restrict the freedom of positioning the ductwork for the various zones.

### SUMMARY OF THE INVENTION

The present invention uses a purge airstream that uses warm air from a zone of a rotor after the regeneration zone to preheat the air to be further heated for supply to the regeneration zone, and a recycled isolation loop that cools the rotor material on the process air inlet side and pre-warms the rotor before it enters the regeneration sector. One or more of the recycled isolation loops can be provided to reduce cross-contamination between sorption and desorption zones of the rotor caused by pressure imbalances and large vapor pressure differences of the various fluid streams.

As used herein, “cycle of operation” means a path of movement of the sorbent mass or rotor during which the sorbent mass or rotor undergoes both a sorption and desorption process. The term “sequentially” refers to a relative order, but does not necessarily require that one immediately follow another. In this embodiment, for example, even if another zone were interposed between the first zone and the second zone, it would still be accurate to say that the sorbent mass sequentially passes through the first zone, the second zone, and so on.

In one aspect, the invention relates to a rotary sorption system that includes a rotor formed of a rotating sorbent mass of a regenerable sorbent material, in a cycle of operation, a given volume of the sorbent mass sequentially passing through first, second, third, fourth, and fifth zones, before returning to the first zone; a supply fluid stream directed through the first zone; a regeneration fluid stream directed through the third zone; and an isolation fluid stream that recirculates in a closed loop independent of the process fluid stream and the regeneration fluid stream through the second and fourth zones, wherein a portion of the supply fluid stream passes through the fifth zone before joining the regeneration fluid stream and passing through the third zone, and no seal or barrier is disposed at a face of the rotor between the first zone and the fifth zone.

In another aspect, the invention relates to a rotary sorption system that includes a rotor formed of a rotating sorbent mass of a regenerable sorbent material, in a cycle of operation, a given volume of the sorbent mass sequentially passing through first, second, third, fourth, and fifth zones, before returning to the first zone; a process fluid stream directed through the first zone; a regeneration fluid stream directed through the third zone; an isolation fluid stream that recirculates in a closed loop independent of the process fluid stream and the regeneration fluid stream through the second and fourth zones; and a purge fluid stream directed through the fifth zone, wherein the purge fluid stream passes through the fifth zone before being further heated and passing through the third zone as the regeneration fluid stream, and no barrier or seal is disposed between the process fluid stream and the purge fluid stream upstream of the rotor before the process fluid stream and the purge fluid stream pass through the first zone and the fifth zone.

In a further aspect, the invention relates to a rotary sorption system that includes a rotor formed of a rotating sorbent mass of a regenerable sorbent material, in a cycle of operation, a given volume of the sorbent mass sequentially passing through first, second, third, fourth, and fifth zones, before returning to the first zone; first ductwork configured to direct a supply fluid stream through the first zone and the fifth zone; second ductwork configured to direct a regeneration fluid stream through the third zone; third ductwork configured to direct an isolation fluid stream to recirculate in a closed loop independent of the process fluid stream and the regeneration fluid stream through the second and fourth zones; and fourth ductwork configured to direct a first portion of the supply fluid stream, having passed through the fifth zone, to the second ductwork to join the regeneration fluid stream, and to direct a second portion of the supply fluid stream, having passed through the first zone, to a process target, wherein the first portion of the supply fluid stream, having passed through the fifth zone, joins the regeneration fluid stream before passing through the third zone.

A better understanding of these and other aspects of the present invention may be had by reference to the drawings and to the accompanying description, in which preferred embodiments of the invention are illustrated and described.

### BRIEF DESCRIPTION OF THE DRAWINGS

FIG. 1 is a schematic flow diagram illustrating a preferred embodiment of a rotary sorption system in accordance with the invention.

FIG. 2 is an elevation view of the sectors of a sorbent rotor including seals and/or partitions in the preferred embodiment of the rotary sorption system in accordance with the invention.

FIG. 3 is a partial sectional top view illustrating airflows in the rotary sorption system in accordance with the invention.

FIG. 4 is a partial sectional perspective view illustrating components in the rotary sorption system in accordance with the invention.

FIG. 5 is a partial sectional elevation view illustrating airflows in the rotary sorption system in accordance with the invention.

### DETAILED DESCRIPTION OF THE PREFERRED EMBODIMENTS

The present invention will now be described with reference to the accompanying drawings, which are illustrative of certain embodiments of the invention. Variations and modifications are possible without departing from the spirit and scope of the invention.

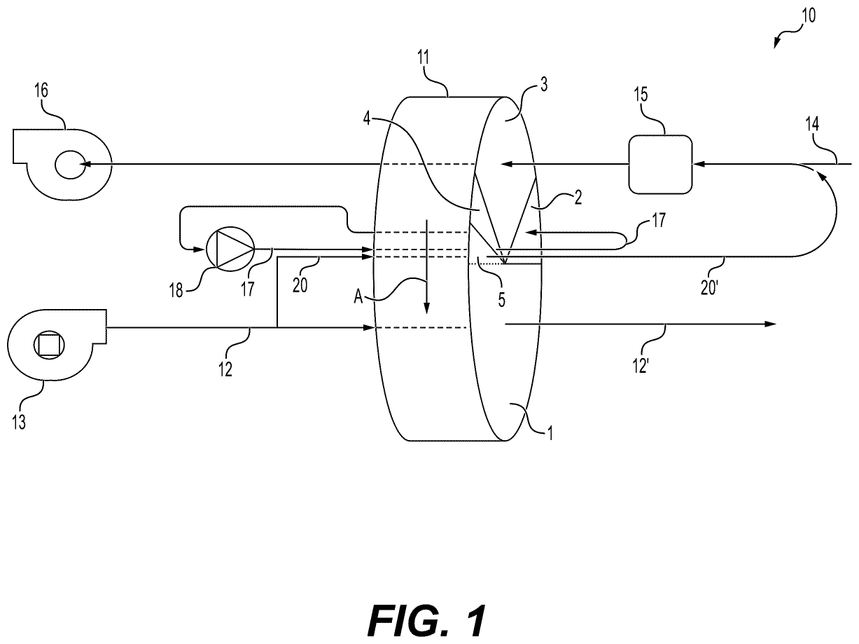

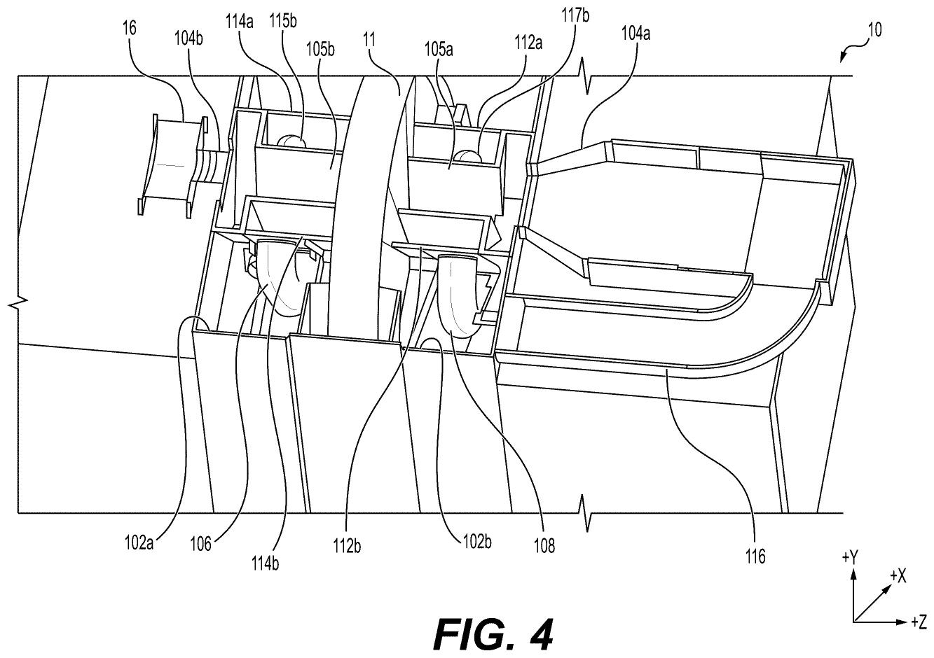

FIGS. 1-5 illustrate an embodiment of the present invention. In the figures, the direction of flow is designated as the +Z (or −Z) direction, the horizontal direction transverse to the direction of flow as the +X (or −X) direction, and the vertical direction as the +Y (or −Y) direction. In the following description, the reactivation air flows in the +Z direction and the process air flows in the −Z direction, but such is not intended to be limiting. For example, the reactivation air and the process air can be designed to flow in the same direction.

Attention first is directed to FIG. 1, which is a schematic flow diagram illustrating a preferred embodiment of a rotary sorption system 10 in accordance with the invention. The system includes a rotating disk-shaped porous mass or rotor 11 of a conventional construction containing or coated with regenerable sorbent material that, in a cycle of operation, sequentially passes through five zones, namely, a first zone 1, a second zone 2, a third zone 3, a fourth zone 4, and a fifth zone 5. The sorbent rotor 11 is rotated about its axis in the direction indicated by arrow A by a known rotor mechanism (not shown). The air to be dried is generally referred to as process air and the air used to regenerate the desiccant is referred to as regeneration or reactivation air. The five zones, in order in the direction of rotation of the rotor 11, can be identified as a process zone 1 through which supply or process air flows, a first isolation zone 2 through which recycled isolation air flows to pre-warm the rotor, a regeneration zone 3 through which heated regeneration air flows, a second isolation zone 4 through which the recycled isolation air flows to be warmed, and a purge zone 5 through which the purge air flows to be simultaneously pre-warmed and dried prior to joining the regeneration air and being heated by a separate regeneration heater.

A supply fluid stream or pre-rotor process fluid stream 12 carrying a sorbate (e.g., water vapor) is passed through the sorbent rotor 11 in the first zone 1, where the sorbate is sorbed (i.e., loaded) onto the sorbent rotor 11 and exits as a post-rotor process fluid stream 12′. In the shown embodiment, the process fluid stream moves to the right in the figures, i.e., the +Z direction. The post-rotor process fluid stream 12′exiting the sorbent mass has a reduced sorbate concentration compared to the supply fluid stream entering the sorbent mass. A fan, blower, or other fluid-moving device 13 can be used to drive the process fluid flow through duct work.

A regeneration fluid stream 14 is passed through the sorbent rotor 11 in the third zone 3, in a direction opposite to the flow of the process fluid stream 12, i.e., the leftward or −Z direction. The sorbent from the process fluid stream that was collected in the sorbent mass 11 is released into the regeneration fluid stream, which exits the rotor 11 as a post-rotor regeneration fluid stream 14′. A heater 15 can be provided to heat the regeneration fluid stream 14 prior to its passing through the sorbent mass 11. As with the process fluid stream, a fan, blower, or other fluid-moving device 16 can be used to drive the regeneration fluid flow. However, in some cases, the reactivation fan, blower, or other fluid-moving device is not required to generate the regeneration airflow. For example, one or more other fluid-moving devices in the system can be adjusted to generate the regeneration fluid flow without a dedicated regeneration fluid flow source.

Although in FIG. 1 the regeneration fluid stream 14 is not shown as being a closed loop circuit, those skilled in the art will appreciate that that fluid stream can be at least partially recirculated in a closed loop. For example, upon exiting the sorbent mass, the post-rotor regeneration fluid stream 14′ can be cooled to condense vapor out of the fluid stream and then be reheated before being routed back through the sorbent mass.

An isolation fluid stream 17 is recycled in a closed loop, independent of the supply and process fluid stream 12, 12′ and the regeneration fluid stream 14, between the sorbent mass 11 in the second zone 2 and in the fourth zone 4. A pre-rotor purge fluid stream 20 flows from the pre-rotor supply fluid stream 12 through the fifth zone disposed immediately after the fourth zone and exits the rotor 11 as a post-rotor purge fluid stream 20′. That is, the supply fluid stream is the source of the pre-rotor process fluid stream 12 and the pre-rotor purge fluid stream 20. The post-rotor purge fluid stream 20′ joins and becomes at least part of the supply of the regeneration fluid stream 14 and can be driven by fluid-moving devices 13, 16. In some cases, all of the regeneration fluid stream 14 is supplied from the post-rotor purge fluid stream 20′. In such cases, all of the fluid in regeneration fluid stream 14 passes through the fifth zone 5 before passing through the third zone 3. Preferably, the direction that the isolation fluid stream 17 flows through the sorbent mass 11 is the same direction as the fluid flowing through the zone immediately following the isolation zone in the direction of rotation of the sorbent mass 11. In FIG. 1, for example, the isolation fluid stream 17 passes through the second zone 2 in the same direction that regeneration fluid stream 14 flows through the third zone 3 (−Z direction), and passes through the fourth zone 4 in the same direction that the purge fluid stream 20 flows through the fifth zone 5 (+Z direction).

Alternatively, the direction that the isolation fluid stream flows through the sorbent mass could be opposite from the direction of fluid flow through the zone immediately following the isolation zone in the direction of rotation of the sorbent mass. A fan, blower, or other fluid-moving device 18 can optionally be provided to drive the isolation fluid flow. Providing the recycled isolation loop helps to reduce cross-contamination between the process fluid stream 12 and the regeneration fluid stream 14. Separate fans 16, 18 are used for the purge/regeneration stream and recycled isolation loop, as well as for the process air stream (fan 13).

The pre-rotor purge fluid stream 20, which is a portion of supply air 12, uses heat from the purge zone 5 of the rotor to preheat the air to be further heated for supply to the regeneration zone 3. The pre-rotor purge air 20 is dehumidified by the rotor 11, thereby creating a lower relative humidity in the post-rotor purge air for subsequent supply to the regeneration zone. Regeneration of the rotor at a lower relative humidity creates the potential to achieve a lower dew point for the process leaving air.

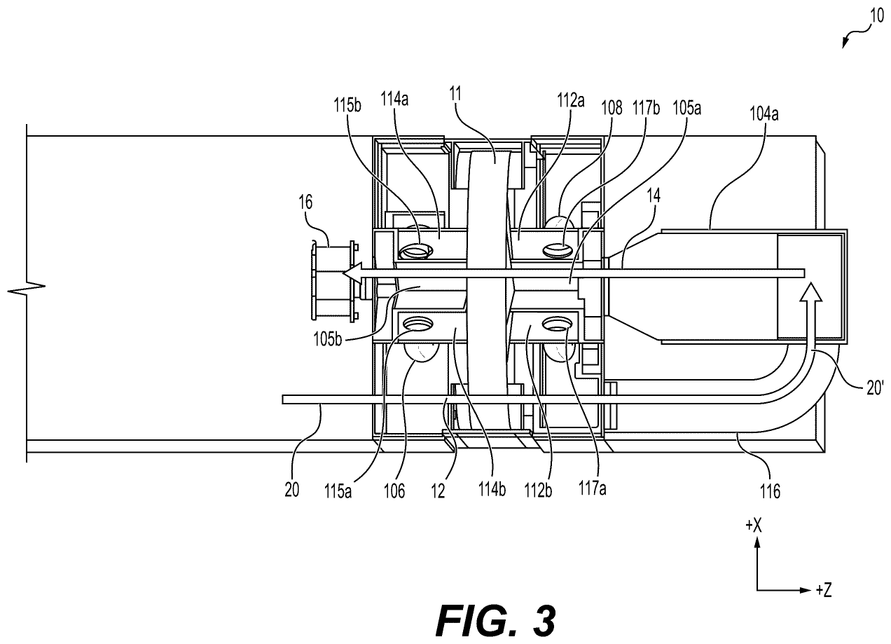

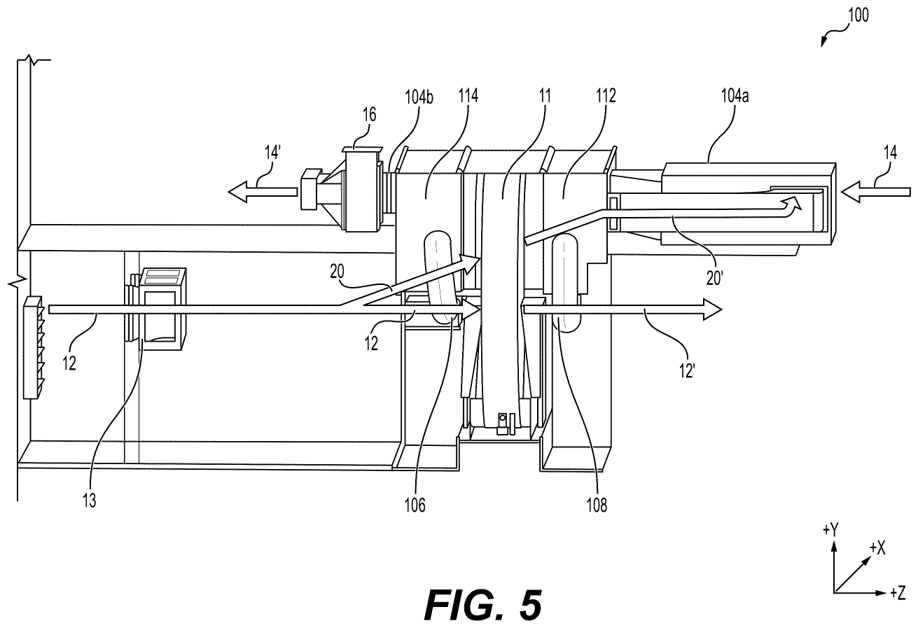

The structure for defining the pathways for the various fluid streams will now be described with reference to FIGS. 3-5. In the following description, structures for defining the fluid flow pathways will be described as “ductwork” and “plenums.” However, the invention should not be limited to these structures as described, and any known structures may be used as long as they can function as intended. That is, for example, while ductwork of a particular shape may be shown and described for a particular passageway, the invention should not be limited to such for that particular passageway, and ductwork of a different shape, plenums, or any other known structure for fluid passage can be used. Likewise, while the claims may recite ductwork for defining particular passageways, such should not be construed as being only ductwork as defined in the traditional sense, but rather any suitable structure for guiding fluid flow and equivalents. In one embodiment, at least some of the structural components can be made of galvanized sheet metal, but such is not to be limiting, and any suitable materials that have desired characteristics, such as structural strength and resistance to environmental conditions, may be used. As shown in FIGS. 3 and 5, the pre-rotor supply airstream 12 is guided from fan 13 through upstream process ductwork and/or plenum 102a to the upstream face of the rotor 11. Partitions and seals, as will be discussed later, are provided as is known in the art so as to ensure the supply airstream 12 passes through the first and fifth zones without leakage to adjacent ductwork or zones. Similarly, the regeneration airstream 14 driven by fan 16 is guided through upstream regeneration ductwork 104a to the third zone of the rotor. Likewise, partitions and seals are provided to ensure the regeneration airstream 14 passes through the third zone without leakage to adjacent ductwork or zones. The isolation fluid stream 17 is recycled in a closed loop, independent of the process fluid stream 12 and the regeneration fluid stream 14, between the second zone 2 and the fourth zone 4 using first connecting ductwork 106 that communicates a first left-side isolation plenum 114a associated with the second zone with a second left-side isolation plenum 114b associated with the fourth zone, as well as second connecting ductwork 108 that communicates a first right-side isolation plenum 112a associated with the second zone with a second right-side isolation plenum 112b associated with the fourth zone.

The four isolation plenums are preferably of a size and shape that are complementary to the shape of the zones 2 and 4 of the rotor 11, such as pie-shaped chambers. Each isolation plenum 112a, 112b, 114a, 114b is formed of walls that define the shape of the chamber, including, in the shown example, two converging side walls, a rear wall distal from the rotor, and an unshown top wall. Each isolation plenum includes an open face that adjoins the face of rotor 11, with the periphery of the open face being provided with face seals to seal against the face of the rotor 11 to ensure the isolation airstreams are delivered to the second and fourth zones without leakage to adjacent ductwork or zones. As such, pressurized fluid within an isolation plenum is forced through the rotor into the corresponding isolation plenum on the opposite side of the rotor, for example, from isolation plenum 112a to isolation plenum 114a. The connecting ductwork 106, 108 for the isolation stream 17 connects to the interiors of the respective plenums 112a, 112b, 114a, 114b through respective ports 115a, 115b and 117a, 117b.

As noted above, pre-rotor regeneration airstream 14 driven by fan 16 is guided through upstream regeneration ductwork 104a. After it passes through rotor 11, the post-rotor regeneration airstream 14 is guided by downstream regeneration ductwork 104b to be exhausted from the system or otherwise processed. Upstream regeneration ductwork 104a and downstream regeneration ductwork 104b include transitions 105a, 105b that direct the regeneration airflow to and from the rotor. Upstream regeneration transition 105a and downstream regeneration transition 105b can be formed in any known manner, such as the by sheet metal working. As, in the shown embodiment, regeneration transitions 105a, 105b pass between pairs of isolation plenums 112a, 112b and 114a, 114b, each side wall of the regeneration plenums can share a common side wall with an adjacent isolation plenum. As noted above, seals are provided at the periphery of the regeneration transitions at the face of the rotor 11 to ensure the regeneration airstream 14 passes through the third zone without leakage to adjacent ductwork or zones.

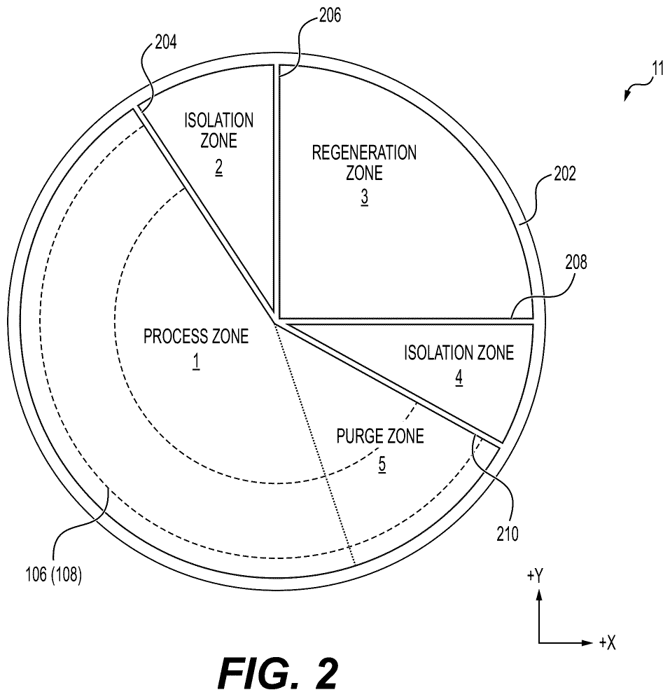

The seals used to seal the various plenums and ductwork against the faces of rotor 11 will now be discussed with reference to FIG. 2. Any known seals in the field of HVAC, particularly those used in rotary sorption systems, can be employed. The seals can be plural in number with respect to each face of the rotor, and can be integral or discrete. As shown in FIG. 2, in one embodiment, a peripheral seal 202 is provided at the rotor-side of the periphery of the ductwork and plenums at each face of the rotor. Alternatively or in addition, a peripheral seal can be provided along the periphery of the rotor 11 itself. Further, radial seals 204, 206, 208, and 210 are provided at the rotor-side of the ductwork and plenums between zones 1 and 2, 2 and 3, 3 and 4, and 4 and 5, respectively. Where adjacent plenums or ductwork share a radial wall, a single radial seal can be provided at that location, but parallel, abutting seals can also be used. No seal is disposed between zones 1 and 5, as shown by the dotted line in FIG. 2.

As shown in FIGS. 3-5, the connecting ductwork 106, 108 for the isolation streams 17 is disposed on both sides of the rotor and connects the respective isolation plenums 112a, 112b and 114a, 114b in planes parallel to the faces of the rotor. As shown, the connecting ductwork 106 on the left side loops from isolation plenum 114a at a region adjacent isolation zone 2 to isolation plenum 114b at a region adjacent isolation zone 4, substantially through at least a portion of the upstream process air plenum 102a. Likewise, connecting ductwork 108 on the right side loops from isolation plenum 112a at a region adjacent isolation zone 2 to isolation plenum 112b at a region adjacent isolation zone 4, substantially through at least a portion of the downstream process air plenum 102b. Fluid-moving device or fan 18 can be provided in either connecting ductwork 106 or 108. The looping of connecting ductwork 106, 108 is shown in phantom in FIG. 2. Such an arrangement allows a compact design of the system. That is, the connection between the respective isolation plenums can be housed in a narrow space on either side of the rotor in the process air plenums, each space having a dimension in the Z direction of sufficient size to accommodate the width of the connecting ductwork 106, 108, that is, in the shown embodiment, the diameter of the connecting ductwork. However, any barrier defining the fifth zone could restrict this compact design by interfering with the shortest paths for the isolation airstream connection ductwork 106, 108. Accordingly, no seal or barrier is positioned between the first zone and the fifth zone, at least on the upstream side of the rotor with respect to the direction of the supply airflow. That is, no obstruction or barrier is present in upstream process air plenum 102a. This allows the supply air to enter both the first and fifth zones without being physically separated upstream of the rotor.

In a preferred embodiment, the compact design also applies to the post-rotor side of the process and purge streams, so partitions and/or seals can also be eliminated downstream of and between the first and fifth zones. Accordingly, no seal or barrier is positioned between the first zone and the fifth zone on the downstream side of the rotor with respect to the direction of the supply airflow, so no obstruction or barrier is present in downstream process air plenum 102b.

On the downstream side of the first and fifth zones, ductwork can be connected to downstream process air plenum 102b to direct the air that has passed through the first and fifth zones to a process target (e.g., a space to be conditioned), and to direct the air that has passed through the fifth zone to join with the ductwork that guides the regeneration airflow. As shown in FIGS. 3-5, post-rotor purge ductwork 116 is connected to downstream process air plenum 102b at one end and to upstream regeneration ductwork 104a at the other. In the shown example, post-rotor purge ductwork 116 is in the form of an elbow, but any suitable shape can be used. As a result, the benefits of the purge airstream, e.g., reclaiming heat from the rotor to use in regeneration, can be retained while providing greater latitude in the design of the ductwork.

It should be noted that the benefits of the invention can be achieved to greater or lesser degrees with other modifications. For example, the purge airstream can be supplied from a different source than the supply airstream and can be directed in an opposite direction. The shown embodiment can also have benefits other than those described above, can also provide latitude in design for other reasons, and can result in cost and material savings regardless of the intended purpose.

Adding a single closed isolation loop to the system can reduce leakage of air by approximately one-half. This is due to the closed loop nature of the isolation loop, which will cause it to equilibrate to an absolute pressure midway between the process and regeneration zones. In certain applications, further benefits can be achieved by providing additional isolation loops. That is, the present invention is not limited to a single isolation loop, but can use two or more isolation loops depending on the characteristics of the various fluid streams and the desired level of treatment. For example, two isolation fluid streams can be recycled in a closed loop, each independent of the supply and process fluid stream 12, 12′, the regeneration fluid stream 14, 14′, and the other isolation fluid stream 17. Preferably, each additional isolation loop is arranged so that the isolation fluid stream passes through the sorbent mass in the same direction as the process or regeneration fluid stream that follows the isolation fluid stream in the direction of rotation of the sorbent mass. It is also preferred that each additional isolation loop be arranged so that, in a cycle of rotation, the sorbent mass sequentially passes through the isolation fluid streams in ascending and then descending order. In other words, for a nine-zone system with three isolation loops, for example, the sorbent mass would sequentially pass through the regeneration fluid stream, a first isolation fluid stream, a second isolation fluid stream, a third isolation fluid stream, the purge fluid stream, the process fluid stream, the third isolation fluid stream, the second isolation fluid stream, the first isolation fluid stream, and so on. The number of isolation loops can be selected based on a determination of whether certain selected criteria relating to temperature, vapor pressure, absolute pressure, and/or leakage are satisfied. Whether the criteria are satisfied can be determined either by simulation or by physical testing. In the event it is determined that one or more of the selected criteria is satisfied, then this indicates that there may be a potential benefit in adding an isolation loop to the system. After the isolation loop is added, the determination is made again, and so on, until the selected criteria are not satisfied. In keeping with the preferred compact design of the invention, ductwork similar to connecting ductwork 106, 108 should be provided for each pair of isolation zones. Such may require modifying the space within process air plenums 102a, 102b to accommodate the additional connecting ductwork.

In the preferred embodiments described above, those of ordinary skill in the art will recognize that the selection of specific flow rates, pressures, temperatures, relative humidities, etc., depends on the particular application for the sorption system, and will be able to make appropriate selections for a given application. In certain applications, the leakage between circuits must be minimized to the greatest extent possible. In concentration cycles, whether it be for VOC concentration or water concentration via closed-loop regeneration in low dew point environments, exfiltration from the process stream can be as detrimental as infiltration, as the concentration ratio of vapor to the regeneration air stream must be maximized for cycle efficiency. Attention should be given to ensure even pressure balances between the process and regeneration circuits to maximize concentration ratios.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A rotary sorption system, comprising:
a rotor formed of a rotating sorbent mass of a regenerable sorbent material, in a cycle of operation, a given volume of the sorbent mass sequentially passing through first, second, third, fourth, and fifth zones, before returning to the first zone;
a supply fluid stream directed through the first zone;
a regeneration fluid stream directed through the third zone; and
an isolation fluid stream that recirculates in a closed loop independent of the process fluid stream and the regeneration fluid stream through the second and fourth zones, wherein a portion of the supply fluid stream passes through the fifth zone before joining the regeneration fluid stream and passing through the third zone, and
no seal or barrier is disposed at a face of the rotor between the first zone and the fifth zone.

2. The system of claim 1, wherein the supply fluid stream and the regeneration fluid stream are passed through the sorbent mass in opposite directions, and the isolation fluid stream is passed through the sorbent mass in the same direction as the fluid stream immediately following the isolation fluid stream with respect to the direction of rotation of the sorbent mass.

3. The system of claim 1, further comprising a heating device disposed in the regeneration fluid stream between the fifth zone and the third zone so as to further heat the regeneration fluid stream before passing through the third zone.

4. The system of claim 1, wherein the supply fluid stream is at a higher pressure than the regeneration fluid stream.

5. The system of claim 1, wherein the supply fluid stream is at a lower pressure than the regeneration fluid stream.

6. The system of claim 1, wherein the process fluid stream is recirculated in a substantially closed loop to dehydrate or maintain dryness of a product.

7. The system of claim 1, wherein the portion of the supply fluid stream passes through the fifth zone of the sorbent mass before joining the regeneration fluid stream and another portion of the supply fluid stream passes through the first zone of the sorbent mass as a process fluid stream.

8. The system of claim 1, wherein the portion of the supply fluid stream that passes through the fifth zone of the sorbent mass is the source of all of the regeneration fluid stream.

9. A rotary sorption system, comprising:
a rotor formed of a rotating sorbent mass of a regenerable sorbent material, in a cycle of operation, a given volume of the sorbent mass sequentially passing through first, second, third, fourth, and fifth zones, before returning to the first zone;
a process fluid stream directed through the first zone;
a regeneration fluid stream directed through the third zone;
an isolation fluid stream that recirculates in a closed loop independent of the process fluid stream and the regeneration fluid stream through the second and fourth zones; and
a purge fluid stream directed through the fifth zone, wherein
the purge fluid stream passes through the fifth zone before being further heated and passing through the third zone as the regeneration fluid stream, and
no barrier or seal is disposed between the process fluid stream and the purge fluid stream upstream of the rotor before the process fluid stream and the purge fluid stream pass through the first zone and the fifth zone.

10. The system of claim 9, wherein the process fluid stream and the regeneration fluid stream are passed through the sorbent mass in opposite directions, and the isolation fluid stream is passed through the sorbent mass in the same direction as the fluid stream immediately following the isolation fluid stream with respect to the direction of rotation of the sorbent mass.

11. The system of claim 9, further comprising a heating device disposed in the regeneration fluid stream so as to further heat the regeneration fluid stream before passing through the third zone.

12. The system of claim 9, wherein the process fluid stream is at a higher pressure than the regeneration fluid stream.

13. The system of claim 9, wherein the process fluid stream is at a lower pressure than the regeneration fluid stream.

14. The system of claim 9, wherein the process fluid stream is recirculated in a substantially closed loop to dehydrate or maintain dryness of a product.

15. The system of claim 9, wherein a portion of a source stream passes through the first zone of the rotating sorbent mass as the process fluid stream and another portion of the source stream passes through the fifth zone of the rotating sorbent mass as the purge fluid stream.

16. A rotary sorption system, comprising:
a rotor formed of a rotating sorbent mass of a regenerable sorbent material, in a cycle of operation, a given volume of the sorbent mass sequentially passing through first, second, third, fourth, and fifth zones, before returning to the first zone;
first ductwork configured to direct a supply fluid stream through the first zone and the fifth zone;
second ductwork configured to direct a regeneration fluid stream through the third zone;
third ductwork configured to direct an isolation fluid stream to recirculate in a closed loop independent of the process fluid stream and the regeneration fluid stream through the second and fourth zones; and
fourth ductwork configured to direct a first portion of the supply fluid stream, having passed through the fifth zone, to the second ductwork to join the regeneration fluid stream, and to direct a second portion of the supply fluid stream, having passed through the first zone, to a process target, wherein
the first portion of the supply fluid stream, having passed through the fifth zone, joins the regeneration fluid stream before passing through the third zone.

17. The system of claim 16, wherein the supply fluid stream and the regeneration fluid stream are passed through the sorbent mass in opposite directions, and the isolation fluid stream is passed through the sorbent mass in the same direction as the fluid stream immediately following the isolation fluid stream with respect to the direction of rotation of the sorbent mass.

18. The system of claim 16, further comprising a heating device disposed in the regeneration fluid stream so as to further heat the regeneration fluid stream before passing through the third zone.

19. The system of claim 16, wherein the supply fluid stream is at a higher pressure than the regeneration fluid stream.

20. The system of claim 16, wherein the supply fluid stream is at a lower pressure than the regeneration fluid stream.

21. The system of claim 16, wherein the supply fluid stream is recirculated in a substantially closed loop to dehydrate or maintain dryness of a product.

22. The system of claim 16, wherein no seal or barrier is disposed at a face of the rotor between the first zone and the fifth zone.

23. The system of claim 16, wherein the first portion of the supply fluid stream that passes through the fifth zone of the sorbent mass is the source of all of the regeneration fluid stream.
